(19) United States
(12) Patent Application Publication
(10) Pub. No.: US 2024/0003376 A1
(43) Pub. Date: Jan. 4, 2024

(54) MANIFOLD WITH REPAIRABLE THREAD INSERT ASSEMBLIES WITHIN MANIFOLD BOREHOLES

(71) Applicant: Hamilton Sundstrand Corporation, Charlotte, NC (US)

(72) Inventors: Jake Rohrig, Simsbury, CT (US); Laurance Robbins, Plainville, CT (US)

(21) Appl. No.: 17/946,333

(22) Filed: Sep. 16, 2022

Related U.S. Application Data
(60) Provisional application No. 63/356,790, filed on Jun. 29, 2022.

(51) Int. Cl. F16B 37/12; F16B 39/10

(52) U.S. Cl. CPC F16B 37/127; F16B 39/10

(57) ABSTRACT

A manifold having a borehole; and a repairable thread insert assembly, including: a shaft inserted in the borehole, the shaft defining: first and second end surfaces spaced apart from each other, wherein the shaft is shorter than the borehole; a threaded through hole extending between the end surfaces; and an outer surface extending between the end surfaces and defining an outer boundary shape that is complementary to the shape of the borehole; an elastic ring; an assembly fastener having a head that compresses the elastic ring between the head of the assembly fastener and the first end surface of the shaft such that the outer surface of the ring is pressed against the borehole, whereby the shaft is locked within the borehole.

### CROSS-REFERENCE TO RELATED APPLICATIONS

This application claims the benefit of U.S. Application No. 63/356,790 filed Jun. 29, 2022, the disclosure of which is incorporated herein by reference in its entirety.

### STATEMENT OF FEDERAL SUPPORT

This invention was made with government support under NNH15CN27C awarded by NASA. The government has certain rights in the invention.

### BACKGROUND

Exemplary embodiments of the present disclosure pertain to the art of fluid distribution and, in particular, to fluid distribution manifolds with repairable thread insert assemblies within manifold boreholes.

A manifold is a fluid distribution system that brings many valves and sensors into one place. Manifolds can, therefor, help improve the overall maintainability of a system in which they are used. As space missions become increasingly distant from the help and safety of Earth, systems need to be maintained by astronauts while in flight. Manifolds are a desirable feature of maintainable systems because of their ability to aggregate many components into one place, improving the accessibility for maintenance. However, removal and replacement of components subject the threads of the manifold to wear and fatigue which can result in the inability to re-seat components onto the manifold. Wear, stripping or cross-threading the manifold may result in a maintenance-induced failure where the mating component may no longer seat/seal properly against the manifold. While manifolds might be repaired by drilling and tapping a new hole, this sort of rework is difficult, if not impossible, for astronauts to perform safely while on mission. Further, drilling and tapping repairs can only occur a limited number of times before material becomes weak or runs out entirely.

### BRIEF DESCRIPTION

Disclosed is a system including: a manifold, including: a first surface configured to seat an implement; a second surface spaced apart from the first surface; and a body extending depth-wise from the first surface to the second surface, wherein the body defines: a borehole that extends depth-wise, partially through the body, from the second surface towards the first surface to define a shaft seat within the body, wherein the borehole has an inner bore surface defining an inner boundary shape; and a body through hole that is coaxially located with the borehole and is radially smaller than the borehole, the body through hole extending to the first surface; and a repairable thread insert assembly, including: a shaft inserted in the borehole, the shaft defining: first and second end surfaces that are axially spaced apart from each other, wherein the shaft is axially shorter than the borehole, and wherein the second end is located at the shaft seat; a threaded through hole extending between the end surfaces; and an outer surface extending between the end surfaces and defining an outer boundary shape that is complementary to the inner boundary shape of the borehole; an elastic ring having an outer surface that, unless compressed, is radially smaller than the borehole; an assembly fastener having a head that compresses the elastic ring between the head of the assembly fastener and the first end surface of the shaft such that the outer surface of the ring is pressed against the inner bore surface of the borehole and the shaft is locked within the borehole.

In addition to one or more aspects of the system, or as an alternate, while the shaft is locked within the borehole, the shaft is further configured for being unlocked and thereafter removed from the borehole when the assembly fastener is rotated such that the ring becomes uncompressed.

In addition to one or more aspects of the system, or as an alternate, the head of the assembly fastener is radially larger than the borehole.

In addition to one or more aspects of the system, or as an alternate, the inner boundary shape of the borehole is noncircular.

In addition to one or more aspects of the system, or as an alternate, the inner boundary shape of the borehole is polygonal.

In addition to one or more aspects of the system, or as an alternate, the ring is formed of one or more polymers.

In addition to one or more aspects of the system, or as an alternate, the shaft is formed of metal.

In addition to one or more aspects of the system, or as an alternate, the shaft is formed of one or more polymers.

In addition to one or more aspects of the system, or as an alternate, the assembly fastener is a screw.

In addition to one or more aspects of the system, or as an alternate, the system further includes: an outer washer and an inner washer, each being radially smaller than the borehole, and wherein the outer washer is positioned between the ring and the head of the assembly fastener, and the inner washer is positioned between the ring and the first end surface of the shaft.

In addition to one or more aspects of the system, or as an alternate, the implement is fastened to the first surface via an implement fastener threaded into the threaded through hole via the body through hole.

In addition to one or more aspects of the system, or as an alternate, the implement is a sensor.

In addition to one or more aspects of the system, or as an alternate, the implement fastener is a screw.

Further disclosed is a space vehicle having a system with one or more of the above described aspects.

Further disclosed is a system including a structure having a borehole; and a repairable thread insert assembly, including: a shaft inserted in the borehole, the shaft defining: first and second end surfaces spaced apart from each other, wherein the shaft is shorter than the borehole; a threaded through hole extending between the end surfaces; and an outer surface extending between the end surfaces and defining an outer boundary shape that is complementary to the shape of the borehole; an elastic ring; and an assembly fastener that is configured to compresses the elastic ring between the head of the assembly fastener and the first end surface of the shaft such that the outer surface of the ring is pressed against the borehole, whereby the shaft is locked within the borehole.

In addition to one or more aspects of the system, or as an alternate, the structure is a manifold.

### BRIEF DESCRIPTION OF THE DRAWINGS

The present disclosure is illustrated by way of example and not limited in the accompanying figures in which like reference numerals indicate similar elements.

FIG. 1A shows a manifold that includes repairable thread insert assemblies that interface with boreholes in the manifold;

FIG. 1B shows a detail of a borehole of FIG. 1A;

FIG. 1C shows a detailed views of a manifold and the repairable thread insert assembly as installed and in an exploded view;

FIG. 1D shows another detail of a borehole of FIG. 1A;

FIG. 2A shows an exploded view of the insert assembly;

FIG. 2B shows an assemble view of the insert assembly;

FIG. 3 shows the insert assemblies in a manifold connecting to one or more sensors, where the manifold is in a spacecraft;

FIG. 4 shows removing an implement and insert assembly from the manifold; and

FIG. 5 shows replacing the insert assembly in the manifold and connecting the implement to the manifold via the insert assembly.

### DETAILED DESCRIPTION

A detailed description of one or more embodiments of the disclosed apparatus and method are presented herein by way of exemplification and not limitation with reference to the Figures.

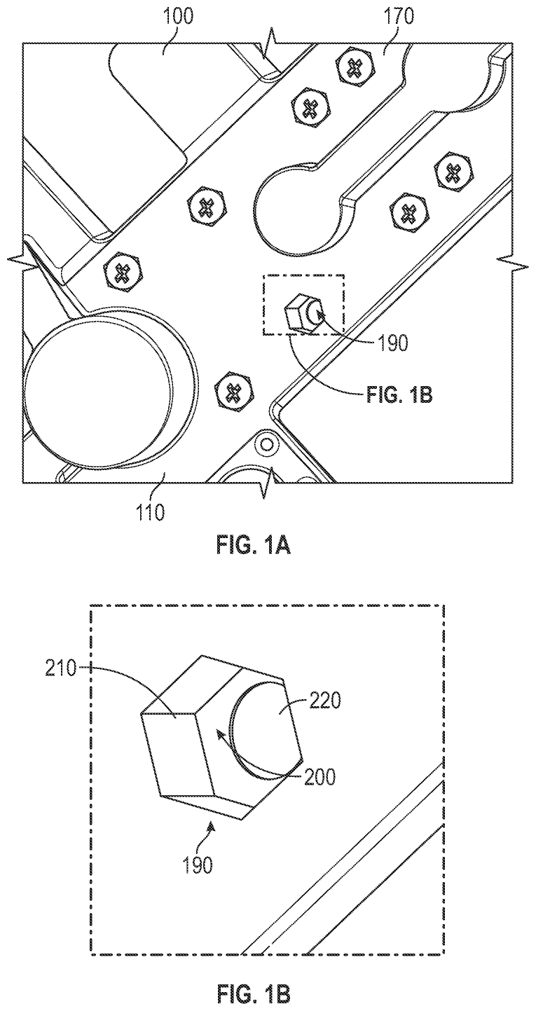

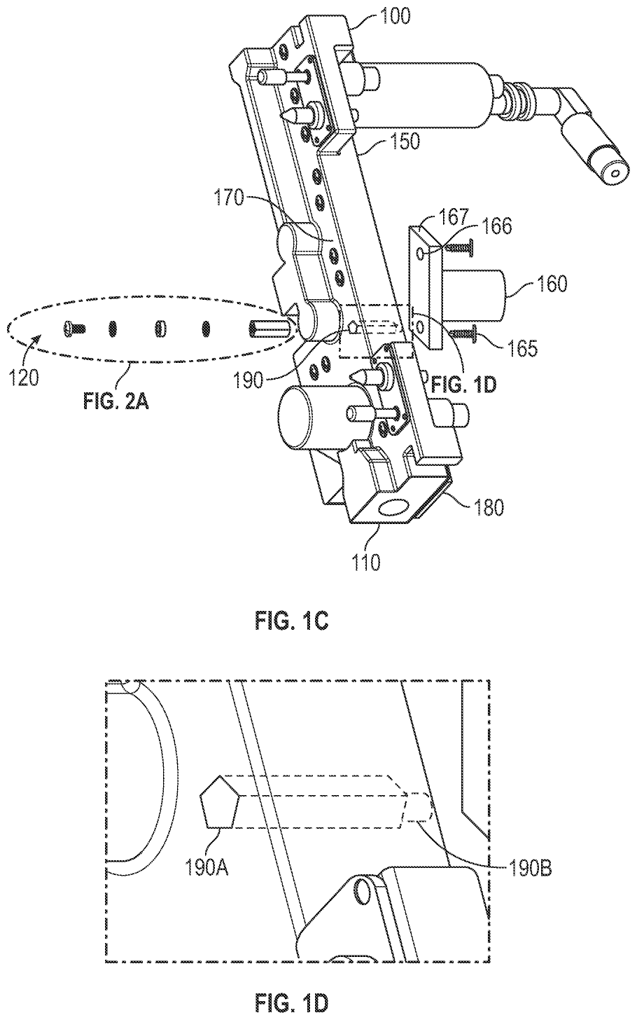

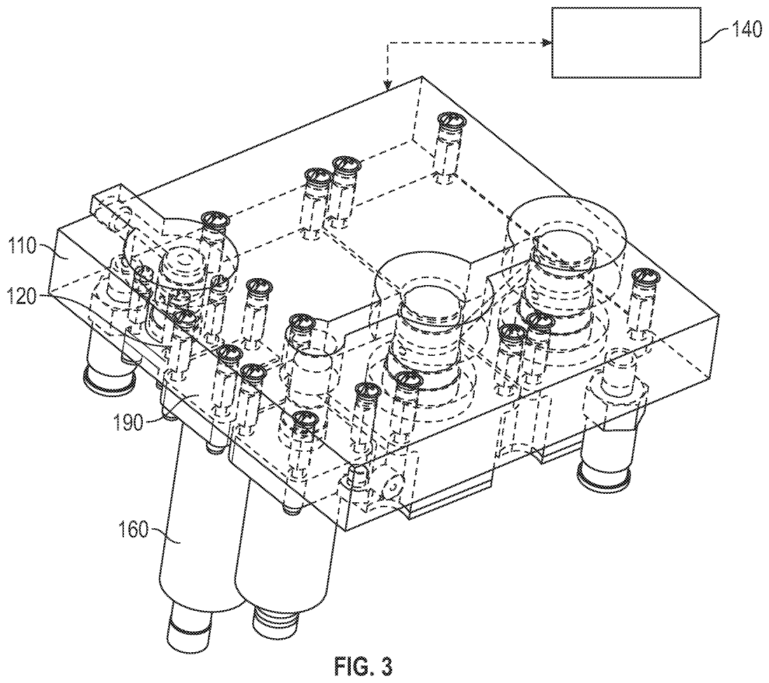

Turning to FIGS. 1A-1D, disclosed is system 100 with a manifold 110 (though other structures are within the scope of the embodiments) and a repairable thread insert assembly (or assembly) 120 that can be used in the manifold 110, e.g., on board a space vehicle 140 (FIG. 3). The manifold 110 includes a first surface 150 configured to seat an implement 160 that is secured with an implement fastener 165 that passes through a hole in a implement flange 167. A second surface 170 is depth-wise spaced apart from the first surface 150. The body 180 includes boreholes 190 formed therein. In one embodiment, each or some of the boreholes 190 can have a same or similar configuration. As such, herein, continued reference will be to the borehole 190. The boreholes 190 may be machined holes in one embodiment.

As shown in FIG. 1D, the borehole 190 includes a wide portion 190A that extends depth-wise partially from the second surface 170 towards the first surface 150 to define a shaft seat 200 within the body 180. The borehole 190 has an inner bore surface 210 that defines an inner boundary shape. The inner boundary shape of the borehole 190 is noncircular and is, for example, polygonal and more specifically hexagonal. The borehole 190 includes a narrow portion 190B formed by a body through hole 220 that is coaxially located with and is radially smaller than the borehole 190. The body through hole 220 extends from the inner bore surface 210 to the first surface 150. The body through hole 220 is sized to allow the implement fastener 165 slide through it with little or no friction therebetween.

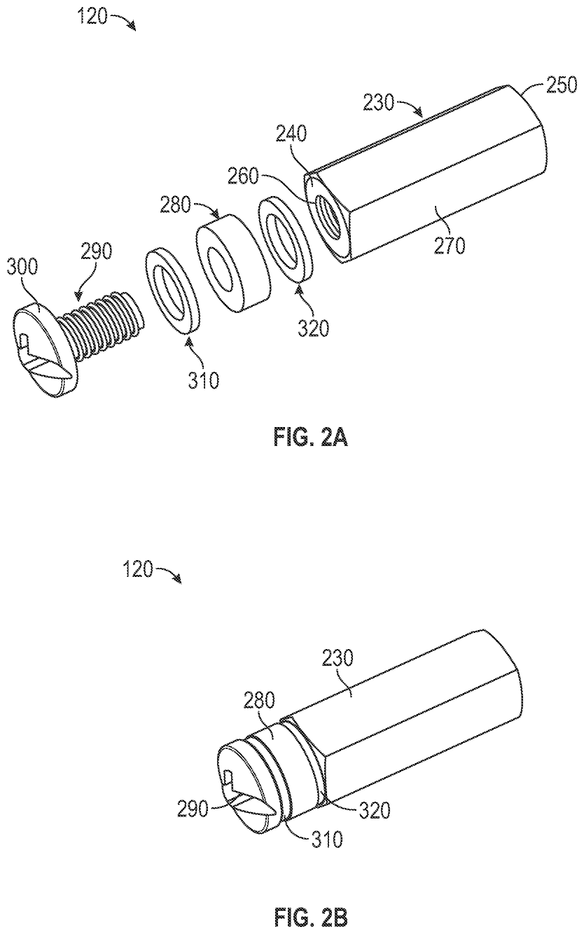

Turning to FIGS. 2A and 2B, detailed views of repairable thread insert assemblies 120 are shown. The assemblies 120 may each have a same configuration so continued reference will be to the assembly 120. Each assembly 120 can be disposed in a borehole 190 of the system 100 from FIG. 1. In one embodiment, there is one assembly 120 for each borehole 190 (FIG. 1B). The assembly 120 includes a shaft 230, or repairable thread insert, that is inserted in the borehole 190. The shaft 230 defines first and second end surfaces 240, 250 that are axially spaced apart from each other. The shaft 230 is axially shorter than the wide portion 190A of the borehole 190. The second end surface 250 is located at the shaft seat 200 (FIG. 1B). A threaded through hole 260 is defined by the shaft 230. The hole 260 extends between the end surfaces 240, 250 of the shaft 230. The threaded through hole 260 is sized to engage the implement fastener 165 (FIG. 1C).

An axial outer surface 270 of the shaft 230 defines an outer boundary shape that is complementary to the inner boundary shape of the borehole 190. This prevents the rotation of the shaft when applying torque while inserting a fastener. An elastic ring, or washer, 280 is sized to fit around the threaded through hole 260 and has an outer surface 270 that, unless compressed, is radially smaller than the borehole 190. An assembly threaded fastener (or assembly fastener) 290, which may be a screw, has a head 300. The head 300 of the assembly fastener is radially larger than the threaded through hole 260 and radially smaller than the borehole 190. An outer washer 310 and an inner washer 320 may be included, each sized to fit between the outer surface 270 and threaded through hole 260. The outer washer 310 may be positioned between the ring 280 and the head 300 of the assembly fastener 290. The inner washer 320 may be positioned between the ring 280 and the first end surface 240 of the shaft 230.

When the fastener 290 is “screwed” into the threads of the shaft, the head 300 compresses the elastic ring 280 between the head 300 of the assembly fastener 290 and the first end surface 240 of the shaft 230. From this compression, the outer surface 270 of the ring 280 is pressed against the inner bore surface 210 of the borehole 190 and the shaft 230 is locked within the borehole 190. While the shaft 230 is locked within the borehole 190, the shaft 230 may be unlocked and thereafter removed from the borehole 190 when the assembly fastener 290 is rotated such that the ring 280 becomes uncompressed. When uncompressed, the ring 280 is radially smaller than the borehole 190. The ring 280 may be made from one or more polymers (synthetic rubber or silicone or other material) that can expand when compressed. The shaft 230 may be made from metal that provides for repeated usage and torquing of the mating hardware. Alternatively, the ring and the shaft may be both formed of one or more polymers

The implement 160 may be fastened to the first surface 150 via an implement fastener 165, which may be a screw, threaded into the threaded through hole 260 via the body through hole 220. The implement 160 may be a sensor.

Thus, the system 100 includes an assembly 120 with an assembly fastener 290, an elastic ring 280, two additional washers 300, 310, and a shaft 230. The shaft 230 is the component that is removed/replaced when threads are damaged. The shaft 230 is retained in its installed position in the manifold 110 by the assembly fastener 290 applying compression loading to the elastic ring 280. The elastic ring 280 expands in the manifold 110, allowing the assembly 120 to be retained in the body 180 and function as a fastener until intentionally removed. That is, the assembly fastener 290, when squeezing the elastic ring 280 between the two additional washers 300, 310, causes the elastic ring 280 to expand outwards. The elastic ring 280 presses up against the inside of the borehole 190 (FIG. 1B), providing friction, and making the assembly 120 into a form of a captive fastener.

As shown in FIG. 3, in one embodiment, assemblies 120 of the kind identified above, installed in boreholes 190 in a manifold 110, engage implements 160, e.g., a sensor, a valve, etc., and the manifold 110 is within the space vehicle 140. These assemblies 120 prevent the implements 160 from falling out of the manifold 110.

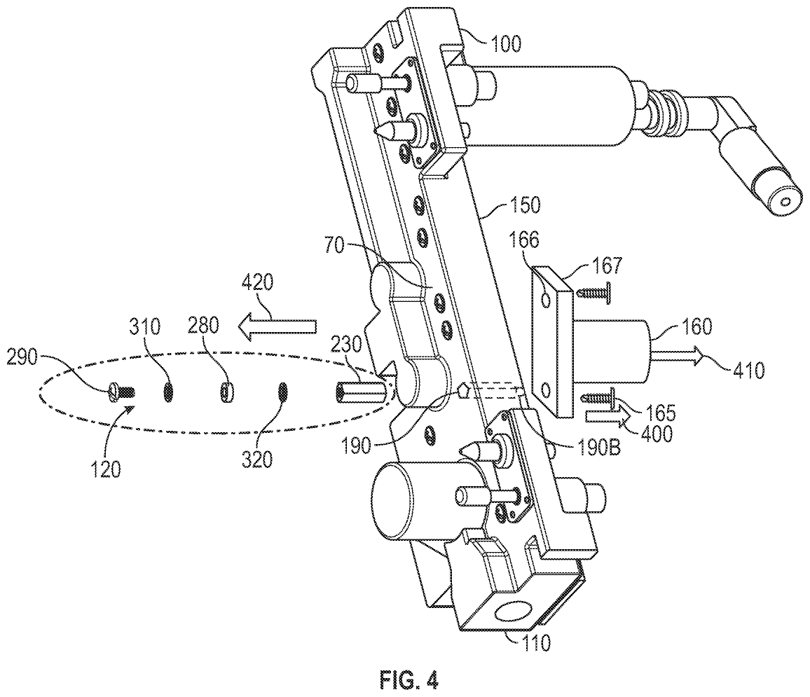

Turning to FIG. 4, in a circumstance where an implement 160 such as a sensor should be replaced, the implement fastener 165 is removed (arrow 400) from the shaft 230. the narrow portion 190B of the borehole 190, and out of the hole 166 in the implement flange 167. Then the implement 160 is moved away first surface 150 of the manifold 110 (arrow 410). If the insert assembly 120 needs to be replaced for any reason, the assembly fastener 290 is removed, i.e., unscrewed from the shaft 230. The ring 280 no longer engages the borehole 190 so that the assembly 120, including the ring 280, washers 310, 320 and shaft 230 are removed from the wide portion 190A of the borehole 190 (arrow 420).

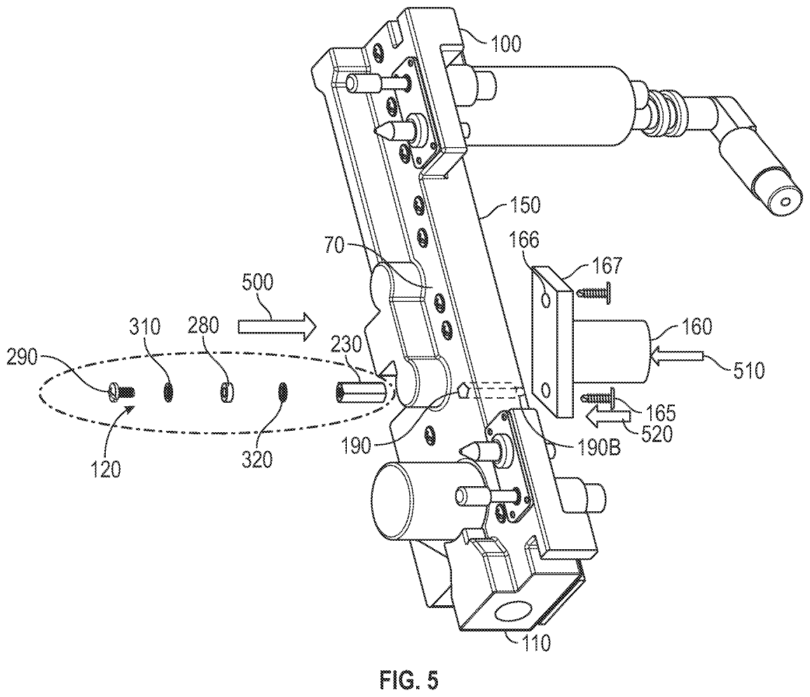

The opposite procedure is followed to mount the replacement implement 160 using the borehole 190 that requires a replacement assembly 120. Turning to FIG. 5 the assembly 120, including the ring 280, washers 310, 320 and shaft 230 are positioned in the wide portion 190A of the borehole 190 (arrow 500). That is, the shaft 230 is inserted first, followed by the inner washer 320, the elastic ring 280 and the outer washer 310. The assembly screw 290 is then “screwed” into the shaft 230 so that the elastic ring 280 expands to engage the borehole 190, fixing the assembly 120 in place. The implement 160 is placed against the first surface 150 of the manifold 110 (arrow 510). The implement fastener 165 is passed through the hole 166 in the implement flange 167, and into the narrow portion 190B of the borehole 190 to engage the shaft 230 (arrow 520). Once the implement fastener 165 is “screwed” into the shaft 230, the implement 160 is fixed to the manifold 110.

It shall be understood based on the disclosure herein that one or more embodiments may provide one or more of the following benefits. However, these benefits are not meant as requirements and are not limiting on the claims unless specifically recited or otherwise mentioned. The embodiments may have a technical effect of, when the manifold failure mode of cross-threading or stripping threads, enabling a replacement the interfacing threads. Embodiments may allow for unlimited thread replacements, limited only by the number of spare parts, and increases system maintainability overall. With the disclosed system, manifold failure mode of cross-threading or stripping threads is eliminated, and drilling and tapping operations are not required to make a repair. Embodiments herein allow the threads of a manifold to be replaced, e.g., utilizing simple hand tools. The disclosed assembly may improve the speed, ease, and safety of a repair. The embodiments prevent metal chips and foreign object debris (FOD) from being generated, which could float into eyes/mouths/noses of crew. Embodiments herein can allow for unlimited thread replacements, up to the quantity of available spare assemblies packed for a mission.

The term “about” is intended to include the degree of error associated with measurement of the particular quantity based upon the equipment available at the time of filing the application. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a manifold, comprising:
a first surface configured to seat an implement;
a second surface spaced apart from the first surface; and
a body extending depth-wise from the first surface to the second surface, wherein the body defines:
a borehole that extends depth-wise, partially through the body, from the second surface towards the first surface to define a shaft seat within the body, wherein the borehole has an inner bore surface defining an inner boundary shape; and
a body through hole that is coaxially located with the borehole and is radially smaller than the borehole, the body through hole extending to the first surface; and
a repairable thread insert assembly, comprising:
a shaft inserted in the borehole, the shaft defining:
first and second end surfaces that are axially spaced apart from each other, wherein the shaft is axially shorter than the borehole, and wherein the second end is located at the shaft seat;
a threaded through hole extending between the end surfaces; and
an outer surface extending between the end surfaces and defining an outer boundary shape that is complementary to the inner boundary shape of the borehole;
an elastic ring having an outer surface that, unless compressed, is radially smaller than the borehole;
an assembly fastener having a head that compresses the elastic ring between the head of the assembly fastener and the first end surface of the shaft such that the outer surface of the ring is pressed against the inner bore surface of the borehole and the shaft is locked within the borehole.

2. The system of claim 1, wherein:
while the shaft is locked within the borehole, the shaft is further configured for being unlocked and thereafter removed from the borehole when the assembly fastener is rotated such that the ring becomes uncompressed.

3. The system of claim 2, wherein the head of the assembly fastener is radially larger than the borehole.

4. The system of claim 1, wherein the inner boundary shape of the borehole is noncircular.

5. The system of claim 4, wherein the inner boundary shape of the borehole is polygonal.

6. The system of claim 1, wherein the ring is formed of one or more polymers.

7. The system of claim 1, wherein the shaft is formed of metal.

8. The system of claim 6, wherein the shaft is formed of one or more polymers.

9. The system of claim 1, wherein the assembly fastener is a screw.

10. The system of claim 1, further comprising:
an outer washer and an inner washer, each being radially smaller than the borehole, and
wherein the outer washer is positioned between the ring and the head of the assembly fastener, and the inner washer is positioned between the ring and the first end surface of the shaft.

11. The system of claim 10, wherein:
the implement is fastened to the first surface via an implement fastener threaded into the threaded through hole via the body through hole.

12. The system of claim 11, wherein the implement is a sensor.

13. The system of claim 11, wherein the implement fastener is a screw.

14. A space vehicle comprising the system of claim 11.

15. A system including
a structure having a borehole; and
a repairable thread insert assembly, including:
a shaft inserted in the borehole, the shaft defining: first and second end surfaces spaced apart from each other, wherein the shaft is shorter than the borehole;
a threaded through hole extending between the end surfaces; and
an outer surface extending between the end surfaces and defining an outer boundary shape that is complementary to the shape of the borehole;
an elastic ring; and
an assembly fastener that is configured to compresses the elastic ring between the head of the assembly fastener and the first end surface of the shaft such that the outer surface of the ring is pressed against the borehole, whereby the shaft is locked within the borehole.

16. The system of claim 15, wherein the structure is a manifold.
